(19) United States
(12) Patent Application Publication
(10) Pub. No.: US 2018/0053263 A1
(43) Pub. Date: Feb. 22, 2018

(54) METHOD AND SYSTEM FOR DETERMINATION OF QUANTITY OF FOOD CONSUMED BY USERS

(71) Applicant: Wipro Limited, Bangalore (IN)

(72) Inventors: Vijay KUMAR, Bangalore (IN); Ramya KOLLI, Andhra Pradesh (IN); Shagun RAI, Allahabad (IN)

(73) Assignee: Wipro Limited

(21) Appl. No.: 15/279,503

(22) Filed: Sep. 29, 2016

(30) Foreign Application Priority Data
Aug. 17, 2016 (IN) 201641028071

(51) Int. Cl. G06Q 50/12; G06Q 30/04; G06K 9/00; G06K 9/20

(52) U.S. Cl. CPC G06Q 50/12; G06Q 30/04; G06K 2209/17; G06K 9/00771; G06K 9/209; G06K 9/00335

(57) ABSTRACT

The present disclosure discloses a method and a system for determining quantity of food consumed by users. The method comprising receiving one or more inputs from a first set of sensors and a second set of sensors associated with the determination unit, where the first set of sensors and the second set of sensors monitor one or more users and food served to the one or more users respectively, identifying each type of food from the food served, identifying each of the one or more users and actions performed by each of the one or more users to consume the food and determining quantity of each type of food consumed by each of the one or more users based on the identified actions performed by each of the one or more users.

### TECHNICAL FIELD

The present disclosure relates to quantitative systems. More particularly and specifically, the present disclosure discloses a method and a system for real time determination of quantity of food consumed by users.

### BACKGROUND

Consider a scenario where a group of people having lunch at a restaurant, would like to share bill for food ordered and food consumed. Currently, there are numerous applications where a user inputs types of food ordered, number of people sharing the bill, amount of food consumed etc. The application then generates a bill for each user sharing the bill. Here, users have to manually key in the inputs to the application. Also, the inputs may not be accurate and hence the bill generated may not he according to actual amount of food consumed by each user. Hence, the users will not contribute accurately towards the bill generated by the conventional devices and systems. Thus, existing systems do not provide itemized bill according to food consumed by users.

### SUMMARY

In an embodiment, the present disclosure discloses a method for determining quantity of food consumed by users. The method comprises receiving, by a determination unit, one or more inputs from a first set of sensors and a second set of sensors associated with the determination unit, where the first set of sensors and the second set of sensors monitor one or more users and food served to the one or more users respectively, identifying each type of food from the food served, identifying each of the one or more users and actions performed by each of the one or more users to consume the food and determining quantity of each type of food consumed by each of the one or more users.

In an embodiment of the present disclosure, a determination unit for determining quantity of food consumed by users is disclosed. The determination unit comprises a processor and a memory communicatively coupled to the processor, storing processor executable instructions. The processor is configured to receive one or more inputs from first set of sensors and second set of sensors, associated with the determination unit, where the first set of sensors and the second set of sensors monitor one or more users and food served to the one or more users respectively, identify each type of food from the food served, identify each of the one or more users and actions performed by each of the one or more users to consume the food and determine quantity of food consumed by each of the one or more users,

In an embodiment, the present disclosure provides a system for determining quantity of food consumed by users. The system comprises a first set of sensors to monitor one or more users, a second set of sensors to monitor food served to the one or more users and a determination unit to receive one or more inputs from the first set of sensors and the second set of sensors, associated with the determination unit, identify each type of food from the food served, identify each of the one or more users and actions performed by each of the one or more users to consume the food and determine quantity of food consumed by each of the one or more users.

In another embodiment, a non-transitory computer-readable storage medium for determining quantity of food consumed by users is disclosed, which when executed by a computing device, cause the computing device to perform operations comprising receiving one or more inputs from a first set of sensors and a second set of sensors, where the first set of sensors and the second set of sensors monitor one or more users and food served to the one or more users respectively, identifying each type of food from the food served, identifying each of the one or more users and actions performed by each of the one or more users to consume the food and determining quantity of each type of food consumed by each of the one or more users.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows an exemplary block diagram of a system for determining quantity of food consumed by users in accordance with some embodiments of the present disclosure;

FIG. 2 shows internal architecture of a determination unit for determining quantity of food consumed by users in accordance with some embodiments of the present disclosure;

FIG. 3 of the present disclosure shows a system illustrating process flow for determining quantity of food consumed by users in accordance with some embodiments of the present disclosure;

FIG. 4 shows exemplary flow chart illustrating a method for determining quantity of food consumed by users in accordance with some embodiments of the present disclosure;

FIG. 5 shows a diagram of a napkin holder as an example embodiment used in determination of quantity of food consumed by users in accordance with some embodiments of the present disclosure;

FIG. 6 shows an exemplary scenario where quantity of food consumed by users is determined in accordance with some embodiments of the present disclosure; and

FIG. 7 shows a block diagram of a general purpose computer system for determining quantity of food consumed by users in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments,

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and a system for determining quantity of food consumed by users. The system comprises one or more set of sensors to monitor users, food served, actions of the users, etc. The system then determines quantity of each type of food consumed by each user by monitoring one or more actions of the user. Thereby, the system determines an itemized bill according to quantity of food consumed by each user.

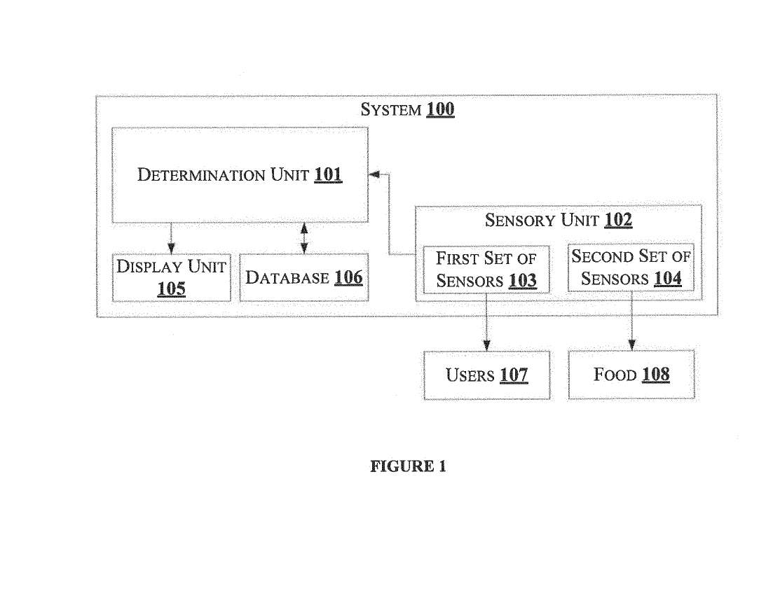

FIG. 1 shows an exemplary block diagram of a system 100 for determining quantity of food consumed by users. The system 100 comprises a determination unit 101, a sensory unit 102., a display unit 105 and a database 106. The sensory unit 102 comprises a first set of sensors 103 and a second set of sensors 104.

The first set of sensors 103 may monitor users 107. In an embodiment, the users 107 may be referred to as one or more users 107 hereinafter in the present disclosure. In an embodiment, the one or more users 107 may refer to persons consuming food 108. In an embodiment, the first set of sensors may include but are not limited to one or more of at least one Red, Green, Blue (RGB) camera, at least one RGB-D (Red, Green, Blue-Depth) camera, at least one spectral camera, at least one Infra-Red (IR) camera or at least one hyperspectral camera.

The second set of sensors monitor the food 10$. Particularly, the second set of sensors 104 monitor the food 108 served to the one or more users 107. In an embodiment, the second set of sensors may include but are not limited to one or more of at least one biosensor, at least one image sensor, at least one thermal sensor or at least one laser sensor.

The determination unit 101 receives one or more inputs from the first set of sensors 103 and the second set of sensors 104 respectively. Further, the determination unit 101 determines each type of food 108 served based on the one or more inputs received from the second set of sensors 104. Likewise, the determination unit 101 identifies each of the one or more users 107 and actions performed by each of the one or more users 107 to consume the food 108 based on the one or more inputs received from the first set of sensors 103. The determination unit 101 determines quantity of each type of food 108 consumed by each of the one or more users 107 based on identified actions performed by each of the one or more users 107. In an embodiment, the determination unit 101 retrieves data from the database 106, regarding amount of food 108 ordered by the one or more users 107. Then, the determination unit 101 calculates a bill for each of the one or more users based on the based on the identified type of food 108, the quantity of food consumed by respective one or more users and the amount of food 108 ordered by the one or more users.

In an embodiment, the database 106 may be associated with a server (not shown in figure) of a service provider providing food service to the one or more users 107. The database 106 is connected to the determination unit by at least one of a wired interface and a wireless interface.

In an embodiment, the display unit 105 displays results generated by the determination unit 101. The display unit 105 can be connected to the determination unit through wired interface or wireless interface.

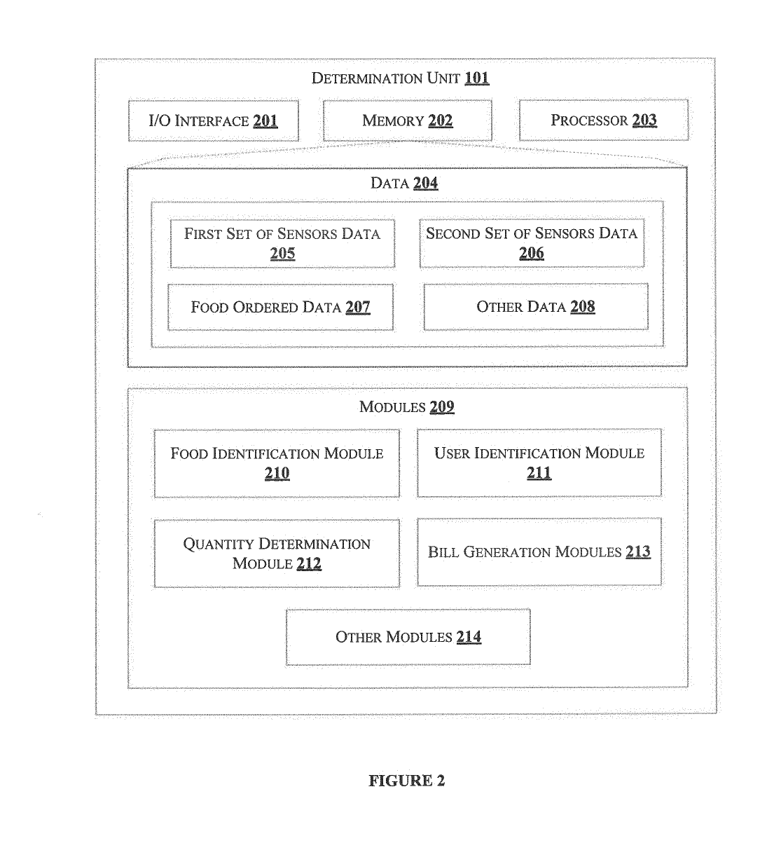

FIG. 2 shows internal architecture of the determination unit 101. The determination unit 101 may include at least one central processing unit (“CPU” or “processor”) 203 and a memory 202 storing instructions executable by the at least one processor 203. The processor 203 may comprise at least one data processor for executing program components for executing user or system-generated requests. User here refers to one or more users 107 as defined in the present disclosure. The memory 202 is communicatively coupled to the processor 203. In an embodiment, the memory 202 stores one or more data 204. The determination unit 101 further comprises an input/Output (I/O) interface 201. The I/O interface 201 is coupled with the processor 203 through which an input signal or/and an output signal is communicated.

In an embodiment, one or more data 204 may be stored within the memory 202. The one or more data 204 may include, for example, first set of sensors data 205, second set of sensors data 206, food ordered data 207 and other data 208. The first set of sensors data 205 includes parameters related to the one or more users 107. The parameters may comprise user Identity (ID), facial recognition data, action recognition data, etc. The second set of sensors data 206 includes parameters related to food 108 served to the one or more users 107. The parameters may comprise type of food 108 served, amount of food 108 served, etc.

In an embodiment, the food ordered data 207 includes amount of food 108 ordered, type of food 108 ordered, etc.

The other data 208 may be used to store data, including temporary data and temporary files, generated by modules 208 for performing various functions of the determination unit 101.

In an embodiment, the one or more data 204 in the memory 202 is processed by modules 209 of the determination unit 101. As used herein, the term module refers to an algorithm running on application specific integrated circuit (ASIC), an electronic circuit, a field-programmable gate arrays (FPGA), Programmable System-on-Chip (PSoC), a combinational logic circuit, and/or other suitable components that provide the described functionality. The said modules 209 when configured with the functionality defined in the present disclosure will result in a novel hardware.

In one implementation, the modules 209 may include, for example, food identification module 210, user identification module 211, quantity determination module 212, bill generation module 213 and other modules 214. It will be appreciated that such aforementioned modules 2.08 may be represented as a single module or a combination of different modules.

In an embodiment, the food identification module 210 identifies the type of food 108 served to the one or more users 107. The food identification module 210 receives the one or more inputs from the second set of sensors 104. The food identification module 210 may receive the one or more inputs from the second set of sensors at predefined intervals of time. The food identification module 210 uses image processing techniques to identify the type of food 108. For example, the food identification module may receive images of food 108 served as inputs. The images can be compared with reference images stored in the database 106 to identify the type of food 108.

in an embodiment, the user identification module 211 identifies each of the one or more users 107 based on the one or more inputs received from the first set of sensors 103. Here, the user identification module 211 may use image processing techniques to identify each of the one or more users 107. Also, actions performed by each of the one or more users to consume the food 108 are identified by the user identification module 211. The actions identified by the user identification module 211 are mapped with the respective one or more users 107.

in an embodiment, the quantity determination module 212 determines amount of food 108 consumed by each of the one or more users 107. The quantity determination module 212 receives inputs from the food identification module 211 and the user identification module 212. Then, the quantity determination module 212 maps the actions performed by each of the one or more users to consume the food 108 with each type of food 108 identified. Further, the quantity determination module 212 determines the quantity of each type of food 108 consumed by each of the one or more users 107 based on the actions performed by each of the one or more users 107 to consume the food 108.

In an embodiment, the bill generation module 213 generates a bill for each of the one or more user based on identified type of food 108, the quantity of food 108 consumed by respective one or more users and amount of food 108 ordered by the one or more users. The bill generation module 213 considers the amount of food 108 ordered by the one or more users 107, type of food 108 ordered by the one or more users 107, amount of food 108 consumed by each of the one or more users 107 to generate an itemized bill for each of the one or more users 107.

In an embodiment, the other modules 214 may include a notification module to notify a staff when the one or more users 107 require attention, communication module to communicate with similar systems for determining quantity of each type of food 108 consumed by the one or more users 107, etc.

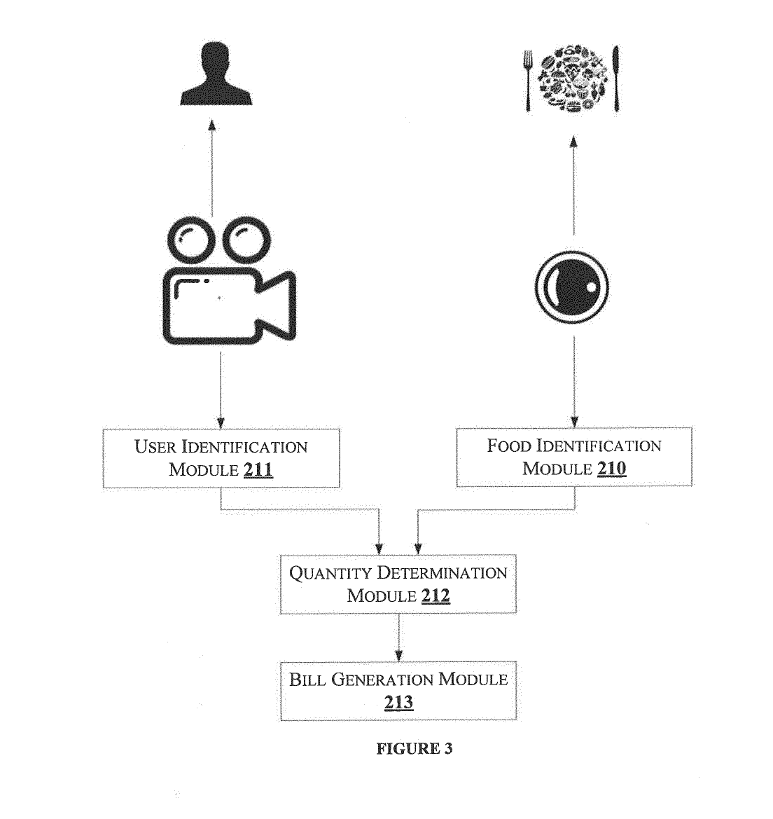

FIG. 3 of the present disclosure shows a system illustrating process flow for determining quantity of each type of food consumed by users in accordance with some embodiments of the present disclosure;

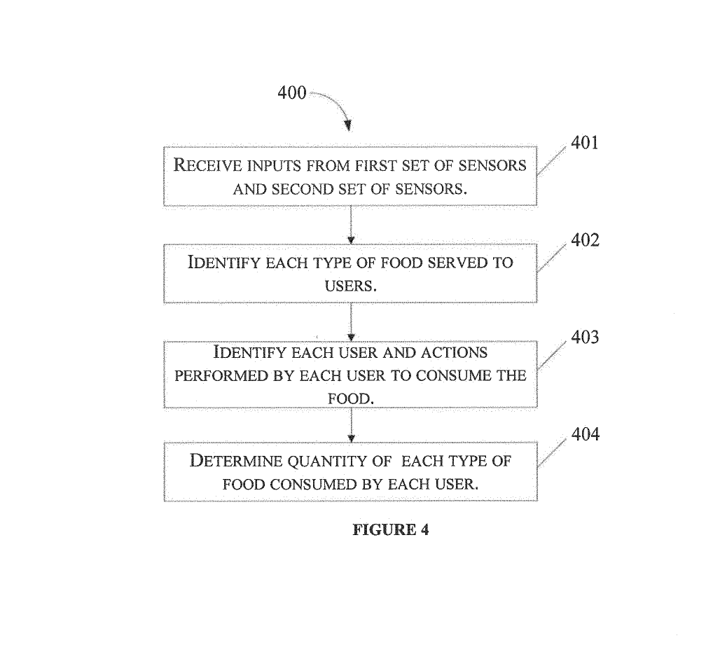

FIG. 4 shows a flow chart illustrating a method for determining quantity of each type of food 108 consumed by each of the one or more users 107.

As illustrated in FIG. 4, the method 400 may comprise one or more steps for determining quantity of each type of food 108 consumed by each of the one or more users 107. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the spirit and scope of the subject matter described herein. Furthermore, the method can he implemented in any suitable hardware, software, firmware, or combination thereof.

At step 401, the user identification module 211 and the food identification module 210 receives the one or more inputs from the first set of sensors 103 and the second set of sensors 104 respectively. The first set of sensors 103 monitor the one or more users 107 and actions performed by the one or more users 107 to consume the food 108. The second set of sensors 104 monitor the food 108 served to the one or more users 107.

At step 402, the food identification module 210 identifies each type of food 108 served to the one or more users 107 based on the one or more inputs received from the second set of sensors 104. The food identification module 210 uses image processing techniques to identify each type of food 108. The food identification module 210 may compare the one or more inputs received from the second set of sensors 104 with reference data to identify the type of food 108. The reference data may be stored in the database 106.

At step 403, the user identification module 211 identifies each of the one or more users 107 and actions performed by each of the one or more users 107 to consume the food 108 based on the one or more inputs received from the first set of sensors 103. Here, the user identification module 211 uses method pertaining to user recognition to identify each of the one or more users 107. Further, the user identification module 211 tracks motion of each of the one or more users 107 to identify when position of respective one or more users are changed. Further, the user identification module 211 identifies actions performed by each of the one or more users 107 to consume the food 108. Here, the user identification module 211 identifies only certain actions performed by each of the one or more users 107 to consume the food 108. Such actions trigger a signal to indicate that respective one or more user 107 has consumed the food 108.

At step 404, the quantity determination module 212 determines quantity of each type of food 108 consumed by each of the one or more users 107 based on the actions performed by each of the one or more users 107. The quantity determination unit 2.12 receives inputs from the food identification unit 210 and the user identification unit 211. Further, the quantity determination unit 212 determines quantity of each type of food 108 consumed by each of the one or more users 107 based on the actions performed by each of the one or more users 107 to consume each type of food 108. The actions performed by the one or more users 107 may include hand movements to pick food 108 from a container to a plate, hand movements to place the food 108 into mouth of a user 107, etc.

In an embodiment, the bill generation module 213 generates a bill for each of the one or more user 107 based on the quantity of food 108 consumed by each of the one or more users 107. The bill generation module receives inputs from the quantity determination module 212 indicating quantity of each type of food 108 consumed by each of the one or more users 107. The bill generation module 213 calculates price for the food 108 consumed by each of the one or more users based on the quantity of food 108 consumed by each of the one or more users 107 and amount of food 108 ordered by the one or more users 107. In an embodiment, the bill generation module 213 may retrieve the food ordered data 207 from the database 106. Also, the bill generation module 213 calculates the price based on predefined price for a particular type of food for predefined quantity.

In an embodiment, the database 106 may be associated with a server (not shown in figure) of a service provider providing food service to the one or more users 107.

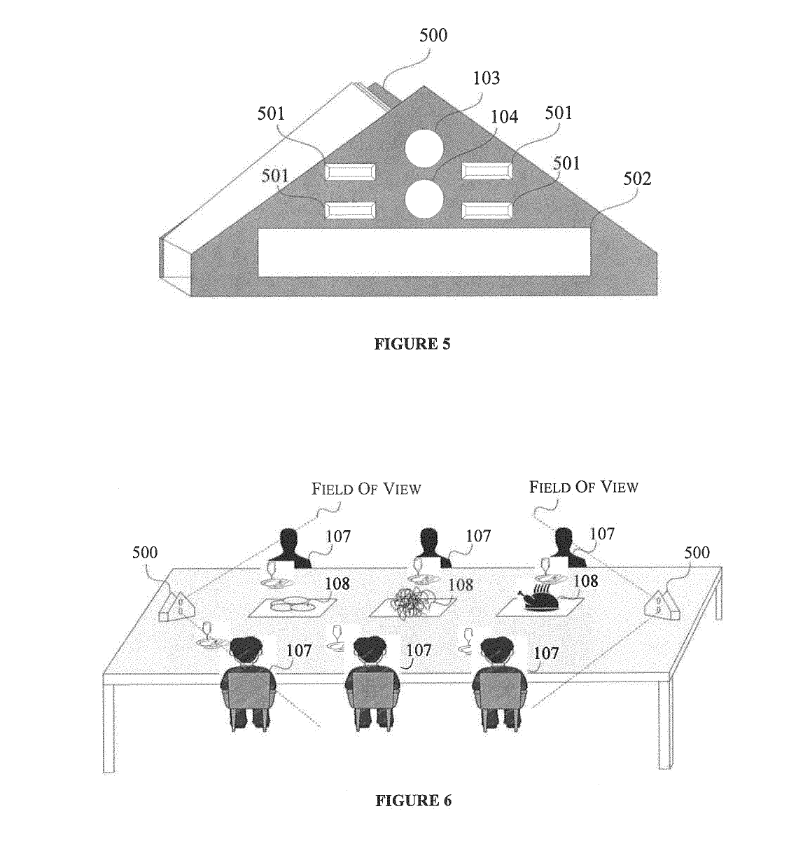

FIG. 5 shows a diagram of a napkin holder 500 as an example embodiment used in determination of quantity of each type of food 108 consumed by users 107. In an embodiment, the napkin folder 500 may comprise the determination unit 101. The determination unit 101 may be embedded in the napkin holder 500. As shown in the FIG. 5, the napkin holder 500 comprises the first set of sensors 103, the second set of sensors 104, a User Interface (U/I) 502 and one or more switches 501. The U/I 502 enables the one or more users 107 to provide one or more inputs to the napkin holder 500. Here, the one or more inputs provided by the U/I 502 may include food ordered data 207, feedback for service provided, etc. The one or more switches 501 can be used to notify a concerned personnel. Each of the one or more switches 501 corresponds to a particular request. For example, the one or more users 107 may notify a concerned personnel for requiring water. In another embodiment, the one or more users 107 may notify a concerned personnel for ordering food 108. Here, a concerned personnel may be a person serving food 108 to the one or more users 107, a person receiving the food order or any other person providing food related service to the one or more users 107. In an embodiment, one or more napkin holders 500 can he used to determine the quantity of each type of food 108 consumed by each of the one or more users 107.

In an embodiment, the determination unit 101 can be placed in a restaurant server. Further, the determination unit 101 can receive the first set of sensor data 205 and second set of sensor data 206 from the first set of sensors 103 and the second set of sensors 104 respectively, embedded in the napkin holder 500. The determination unit 101 then performs the method steps as described in method steps 401 to 404 to determine the quantity of each type of food 108 consumed by the one or more users 107.

FIG. 6 shows an exemplary scenario where quantity of food consumed by users is determined in accordance with some embodiments of the present disclosure. The system comprises one or more napkin holders 500, the one or more users 107 and food 108.

In an embodiment, the one or more napkin holders 500 are placed on a table of a restaurant in such a way that each of the one or more users 107 and the food 108 ordered are within Field of View (FOV) of the first set of sensors 103 and the second set of sensors 104.

In an embodiment, the first set of sensors 103 and the second set of sensors 104 can be used interchangeably. Consider six users 107 to be seated at the table. Let users 107 order three different types of food 108 from a menu displayed to the six users 107. Here, the food 108 ordered is retrieved from the database 106 associated with the restaurant server. Also, price associated with predefined amount of the food ordered is also retrieved from the database 106. In an embodiment, the food ordered can be manually updated into the napkin holder 500 by a concerned personnel. Here, the determination unit 101implemented by the napkin holder 500 is initiated by the concerned personnel. Once the determination unit 101 is initiated, the first set of sensors 103 and the second set of sensors 104 begin to monitor the one or more users 107 and the food 108 served. Let a first user consume two spoons of first type of food, one spoon of second type of food and three pieces of third type of food. Likewise, let each user among the six user consume a portion of each type of food. Here, the actions performed by each user to consume each type of food are monitored by the first set of sensors 103. The action performed by each of the six users is mapped to respective user ID. Also, the type of food served to the six users is monitored by the second set of sensors 104. The determination unit 101 receives the one or more inputs from the first set of sensors 103 and the second set of sensors 104. Further, the determination unit 101 determines quantity of each type of food consumed by each of the six users by mapping the actions performed by each of the six users to consume each type of food. For example, the action performed by the first user to consume first type of food is determined by the determination unit 101. Likewise, actions performed by the first user to consume the second type of food and third type of food is determined by the determination unit 101. The action performed to consume the first type of food may be picking an egg from a container. The action performed to consume the second type of food may be picking up two spoons of noodles. The action performed to consume the third type of food may be picking up chicken pieces from a container. Here, the determination unit 101 determines quantity of first type of food consumed based on number of egg pieces picked up by the first user. The determination unit 101 also maps action of the first user eating the egg pieces. The action of picking up the egg piece and the action of eating the egg piece is considered as an action performed by the first user to consume the first type of food. Similarly, the determination unit identifies action of the first user to consume the second type and third type of food respectively. Based on the actions performed by the first user, the total quantity of food consumed by the first user is determined by the determination unit 101. Similarly, the determination unit 101 determines quantity of each type of food consumed by each of the six users.

The determination unit 101 further generates an itemized bill for each of the six users based on the amount of food consumed by each of the six users and amount of food ordered by the six users. The generated itemized bill is then displayed to the six users by a display unit 105 associated with the napkin holder 500.

In an embodiment, the determination unit 101 identifies a person serving the food to the user and differentiates the person from the user consuming the food. For example, in a restaurant, a server may serve food to users. Here, the action of the server is identified as serving. Since the server has not consumed the food, the action of the server is not considered for determining quantity of each type of food consumed by the users.

In an embodiment, the determination unit 101 can be integrated with mobile applications. Further, the itemized bill can be displayed to users on one or more user devices associated with the determination unit 101.

The napkin holder 500 described above can be considered as an example for implementing the determination unit 101. In an embodiment, the determination unit 101 can be integrated into any system capable of monitoring the users and the food served to the users.

In an embodiment, the bill generated for each of the user can be printed using a printer connected to the determination unit 101. The printer can be connected by at least one of wired interface and wireless interface. Likewise, the database 106 is connected to the determination unit by at least one of a wired interface and a wireless interface.

### Computer System

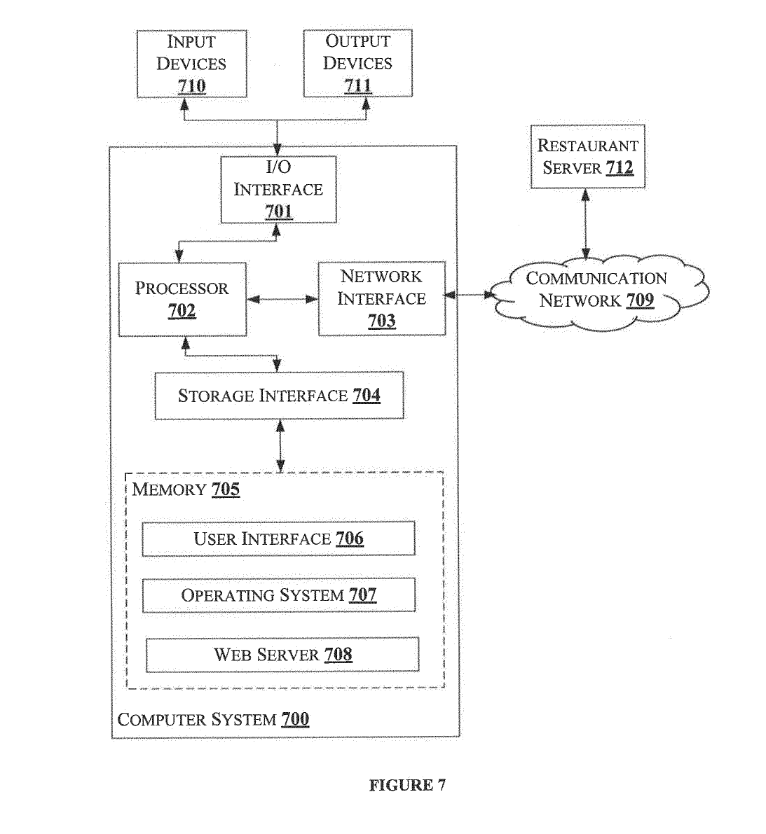

FIG. 7 illustrates a block diagram of an exemplary computer system 700 for implementing embodiments consistent with the present disclosure. In an embodiment, the computer system 700 is used to implement the method for determining quantity of food consumed by users. The computer system 700 may comprise a central processing unit (“CPU” or “processor”) 702. The processor 702 may comprise at least one data processor for executing program components for dynamic resource allocation at run time. The processor 702 may include specialized processing units such as integrated system (bus) controllers, memory management control units, floating point units, graphics processing units, digital signal processing units, etc.

The processor 702 may be disposed in communication with one or more input/output (I/O) devices (not shown) via I/O interface 701. The I/O interface 701 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 701, the computer system 700 may communicate with one or more I/O devices. For example, the input device 710 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 711 may be a printer, fax machine, video display (e.g., cathode ray tube (CRT), liquid crystal display (LCD), light-emitting diode (LED), plasma. Plasma display panel (PDP), Organic light-emitting diode display (OLED) or the like), audio speaker, etc.

In some embodiments, the computer system 700 is connected to the service operator through a communication network 709. The processor 702 may be disposed in communication with the communication network 709 via a network interface 703. The network interface 703 may communicate with the communication network 709. The network interface 703 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 709 may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface 703 and the communication network 709, the computer system 700 may communicate with the one or more service operators.

In some embodiments, the processor 702 may be disposed in communication with a memory 705 (e.g., RAM, ROM, etc. not shown in FIG. 7) via a storage interface 704. The storage interface 704 may connect to memory 705 including, without limitation, memory drives, removable disc drives, etc., employing connection protocols such as serial advanced technology attachment (SAA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, user interface 706, an operating system 707, web server 708 etc. In some embodiments, computer system 700 may store user/application data locally in user interface 706, such as the data, variables, records, etc. as described in this disclosure. Such databases may be implemented as fault-tolerant, relational, scalable, secure databases such as Oracle or Sybase.

The operating system 707 may facilitate resource management and operation of the computer system 700. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, 10 etc.), Apple iOS, Google Android, Blackberry OS, or the like.

In some embodiments, the computer system 700 may implement a web browser 707 stored program component. The web browser 708 may be a hypertext viewing application, such as Microsoft Internet Explorer, Google Chrome, Mozilla Firefox, Apple Safari, etc. Secure web browsing may he provided using Secure Hypertext Transport Protocol (HTTPS), Secure Sockets Layer (SSL), Transport Layer Security (TLS), etc. Web browsers 708 may utilize facilities such as AJAX, DHTML, Adobe Flash, JavaScript, Java, Application Programming Interfaces (APIs), etc. In some embodiments, the computer system 700 may implement a mail server stored program component. The mail server may be an Internet mail server such as Microsoft Exchange, or the like. The mail server may utilize facilities such as ASP, ActiveX, ANSI C++/C∩, Microsoft.NET, CCI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 700 may implement a mail client stored program component. The mail client may be a mail viewing application, such as Apple Mail, Microsoft Entourage, Microsoft Outlook, Mozilla Thunderbird, etc.

In an embodiment, the determination unit 101 may receive order details through the user devices. The user devices may can be indicated by input devices 710. In an embodiment, the determination unit 101 may be associated with a restaurant server 712. The restaurant server 712 may provide the determination unit 101 food ordered data 207.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise,

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may he used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4, show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

In an embodiment, the present disclosure discloses a method to provide users a itemised and quantified bill based on the amount of food consumed.

In an embodiment, the present disclosure discloses a method to improve accuracy of bill distribution between users.

In an embodiment, the present disclosure discloses a method and system for accurately determining amount of food consumed by the users.

Finally, the language used in the specification has been principally selected for readability and instructional purposes, and it may not have been selected to delineate or circumscribe the inventive subject matter, It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| 100 | System |
| 101 | Determination unit |
| 102 | Sensory unit |
| 103 | First set of sensors |
| 104 | Second set of sensors |
| 105 | Display unit |
| 106 | Database |
| 107 | Users |
| 108 | Food |
| 201 | I/O interface |
| 202 | Memory |
| 203 | Processor |
| 204 | Data |
| 205 | First set of sensors data |
| 206 | Second set of sensors data |
| 207 | Food ordered data |
| 208 | Other data |
| 209 | Modules |
| 210 | Food identification module |
| 211 | User identification module |
| 212 | Quantity determination module |
| 213 | Bill generation module |
| 214 | Other modules |
| 500 | Napkin holder |
| 501 | Switches |
| 700 | Computer system |
| 701 | I/O Interface |
| 702 | Processor |
| 703 | Network interface |
| 704 | Storage interface |
| 705 | Memory |
| 706 | User Interface |
| 707 | Operating system |
| 708 | Web server |
| 709 | Communication network |
| 710 | Input devices |
| 711 | Output devices |
| 712 | Restaurant server |

We claim:

1. A method for determining quantity of food consumed by users, comprising:
receiving, by a determination unit, one or more inputs from a first set of sensors and a second set of sensors associated with the determination unit, wherein the first set of sensors and the second set of sensors monitor one or more users and food served to the one or more users respectively;
identifying, by the determination unit, each type of food from the food served based on the one or more inputs received from the second set of sensors;
identifying, by the determination unit, each of the one or more users and actions performed by the each of the one or more users to consume the each type of food based on the one or more inputs received from the first set of sensors; and
determining, by the determination unit, quantity of the each type of food consumed by the each of the one or more users based on the identified actions performed by the each of the one or more users.

2. The method as claimed in claim 1 further comprising calculating a bill for the each of the one or more users based on the each type of food, the quantity of the each type of food consumed by respective one or more users and amount of food ordered by the one or more users.

3. The method as claimed in claim 1, wherein identifying the each type of food comprises comparing the each type of food with predefined data stored in a database associated with the determination unit.

4. The method as claimed in claim 1, wherein determining the quantity of the each type of food consumed comprises mapping the actions of the each of the one or more users with the each type of food consumed by the each of the one or more users.

5. A determination unit for determining quantity of food consumed by users, comprising:
a processor; and
a memory communicatively coupled to the processor, storing processor executable instructions, which, on execution causes the processor to:
receive one or more inputs from first set of sensors and second set of sensors, associated with the determination unit, wherein the first set of sensors and the second set of sensors monitor one or more users and food served to the one or more users respectively;
identify each type of food from the food served based on the one or inure inputs received from the second set of sensors;
identify each of the one or more users and actions performed by the each of the one or more users to consume the each type of food based on the one or more inputs received from the first set of sensors; and
determine quantity of the each type of food consumed by the each of the one or more users based on the identified actions performed by the each of the one or more users.

6. The determination unit as claimed in claim 5, wherein the processor calculates a bill for the each of the one or more users based on the each type of food, the quantity of the each type of food consumed by respective one or more users and amount of food ordered by the one or more users.

7. The determination unit as claimed in claim 5, wherein the processor identifies the each type of food by comparing the each type of food with predefined data stored in a database associated with the determination unit.

8. The determination unit as claimed in claim 5, wherein the processor determines the quantity of the each type of food consumed comprises mapping the actions of the each of the one or more users with the each type of food consumed by the each of the one or more users.

9. A system for determining quantity of food consumed by users, comprising:
a first set of sensors to monitor one or more users;
a second set of sensors to monitor food served to the one or more users; and
a determination unit to:
receive one or more inputs from the first set of sensors and the second set of sensors, associated with the determination unit;
identify each type of food from the food served based on the one or more inputs received from the second set of sensors;
identify each of the one or more users and actions performed by the each of the one or more users to consume the each type of food based on the one or more inputs received from the first set of sensors; and
determine quantity of the each type of food consumed by the each of the one or more users based on the identified actions performed by the each of the one or more users.

10. The system as claimed in claim 10, wherein the determination unit calculates a bill the each of the one or more users based on the each type of food, the quantity of the each type of food consumed by respective one or more users and amount of food ordered by the one or more users.

11. The system as claimed in claim 10, wherein the determination unit identifies the each type of food by comparing the each type of food with predefined data stored in a database associated with the determination unit.

12. The system as claimed in claim 10, wherein the determination unit determines the quantity of the each type of food consumed comprises mapping the actions of the each of the one or more users with the each type of food consumed by the each of the one or more users.

13. The system as claimed in claim 10, wherein the first set of sensors comprises one or more of at least one Red, Green, Blue (RGB) camera, at least one RGB-D (Red, Green, Blue-Depth) camera, at least one spectral camera, at least one Infra-Red (IR) camera or at least one hyperspectral camera.

14. The system as claimed in claim 10, wherein the second set of sensors comprises one or more of at least one biosensor, at least one image sensor, at least one thermal sensor or at least one laser sensor.

15. A non-transitory computer-readable medium storing computer-executable instructions for performing operations comprising:
receiving one or more inputs from the first set of sensors and the second set of sensors, associated with the determination unit;
identifying, each type of food from the food served based on the one or more inputs received from the second set of sensors;
identifying each of the one or more users and actions performed by the each of the one or more users to consume the each type of food based on the one or more inputs received from the first set of sensors; and
determining quantity of the each type of food consumed by the each of the one or more users based on the identified actions performed by the each of the one or more users.

16. The medium as claimed in claim 15, wherein the determination unit calculates a bill the each of the one or more users based on the each type of food, the quantity of the each type of food consumed by respective one or more users and amount of food ordered by the one or more users.

17. The medium as claimed in claim 15, wherein the determination unit identifies the each type of food by comparing the each type of food with predefined data stored in a database associated with the determination unit.

18. The medium as claimed in claim 15, wherein the determination unit determines the quantity of the each type of food consumed comprises mapping the actions of the each of the one or more users with the each type of food consumed by the each of the one. or more users.

19. The medium as claimed in claim 15, wherein the first set of sensors comprises one or more of at least one Red, Green, Blue (RGB) camera, at least one RGB-D (Red, Green, Blue-Depth) camera, at least one spectral camera, at least one Infra-Red (IR) camera or at least one hyperspectral camera.

20. The medium as claimed in claim 15, wherein the second set of sensors comprises one or more of at least one biosensor, at least one image sensor, at least one thermal sensor or at least one laser sensor.
